(19) United States
(12) Patent Application Publication
(10) Pub. No.: US 2009/0320635 A1
(43) Pub. Date: Dec. 31, 2009

(54) TRANSMISSION

(76) Inventors: Ryo Terada, Kawasaki (JP); Toshikuni Shirasawa, Kawasaki (JP)

Correspondence Address: JACOBSON HOLMAN PLLC, 400 SEVENTH STREET N.W., SUITE 600, WASHINGTON, DC, 20004, US

(21) Appl. No.: 12/309,967

(22) PCT Filed: Jul. 27, 2007
(86) PCT No.: PCT/JP2007/064751

§ 371 Date: Feb. 5, 2009

(30) Foreign Application Priority Data
Aug. 16, 2006 (JP) 2006-221915

(51) Int. Cl. F16H 59/04

(52) U.S. Cl. 74/473.36

(57) ABSTRACT

A transmission in which two gears can be selected at the same time is provided without the need to greatly increase the size of the transmission. The transmission comprises a plurality of gear change members arranged for moving in a predetermined shifting direction to select a gear, and a shift operating member which is capable of moving in a selecting direction through notches formed in the gear change members. The shift operating member has an engaging portion capable of engaging with one of the gear change members via the corresponding notch to move the gear change member in the shifting direction. A gap between adjacent gear change members in the selecting direction is larger than a thickness of the engaging portion in the selecting direction.

This is a national stage of PCT/JP07/064,751 filed Jul. 27, 2007 and published in Japanese, which has a priority of Japanese no. 2006-221915 filed Aug. 16, 2006, hereby incorporated by reference.

### TECHNICAL FIELD

The present invention relates to a transmission, and more particularly to a transmission capable of changing gears by selecting and operating a gear change member using a shift operating member.

### BACKGROUND ART

In a conventional so-called parallel shaft-type manual transmission serving as a transmission installed in a vehicle and having a plurality of gears between an input shaft and an output shaft provided in parallel with each other, a gear change is performed by selecting and operating a gear change member such as a shift rail, or a shift jaw or shift fork provided slidably on the shift rail, using a shift operating member that operates in conjunction with a shift lever operated by a driver. Transmissions in which such gear changes are performed automatically have also been developed and put to practical use.

When a gear change is performed in a parallel shaft-type automatic transmission, a state in which two gears are selected simultaneously on a single input shaft cannot be set, and therefore the currently selected and meshed gear is first disengaged, and then a new gear is selected. However, when performing this type of gear change, driving force transmission from a power source to the transmission is temporarily shut off, and as a result, driving force is not transmitted continuously to the drive wheels even when the driver presses an accelerator pedal. This leads to deterioration of the drivability.

To solve this problem, Japanese translation of PCT international application No. 2003-532040 (hereinafter referred to as “Patent Document 1”) and so on have proposed a so-called double clutch transmission in which a first gear mechanism having a plurality of gears is provided between a first input shaft and an output shaft and a second gear mechanism having a plurality of gears is provided between a second input shaft and the output shaft so that driving force from a power source can be transmitted to the first input shaft via a first clutch and this driving force can be transmitted to the second input shaft via a second clutch.

In this double clutch transmission, when a gear of the first gear mechanism is selected such that the driving force from the power source is transmitted to the first input shaft via the first clutch, for example, the second clutch is disengaged such that the driving force from the power source is not transmitted to the second input shaft. At this time, in the second gear mechanism, the predicted gear of the next gear change is selected and meshed in advance such that when a gear change instruction is issued, the second clutch is engaged while disengaging the first clutch, and as a result, power transmission to the drive wheels is performed continuously, thereby improving the drivability.

In the transmission of Patent Document 1, a mechanism in which a gear change member is selected and operated by a shift operating member, such as that described above, is used as the mechanism for performing this type of gear change, and the shift operating member is operated by an actuator.

More specifically, as shown in FIG. 14, a plurality of shift forks 101, 102, 103, 104 serving as gear change members are disposed close to each other in engaging positions for engaging with a shift operating member, and by moving the shift forks 101, 102, 103, 104 in a shifting direction indicated by an arrow SF in FIG. 14, gears corresponding respectively thereto can be selected.

U-shaped notches 105, 106, 107, 108 are formed respectively in the shift forks 101, 102, 103, 104, and one of the shift forks is selected by moving an engaging portion 109 formed on an end portion of the shift operating member through the notches 105, 106, 107, 108 in a selecting direction (indicated by an arrow SL in FIG. 14) perpendicular to the shifting direction. Then, by swinging the shift operating member to move the engaging portion 109 in the shifting direction, the selected shift fork is moved into contact with one of stoppers 110 and 111 provided on either side, and thus gear selection is performed.

FIG. 14 shows a neutral state in which all of the shift forks 101, 102, 103, 104 are set at a middle position between the stoppers 110 and 111 on either side so that none of the gears is selected.

By selecting one shift fork corresponding to a gear of the first gear mechanism and one shift fork corresponding to a gear of the second gear mechanism, from among the shift forks 101, 102, 103, 104, and moving the selected shift forks in the shifting direction from this neutral state, a gear of the first gear mechanism and a gear of the second gear mechanism can be selected simultaneously.

FIG. 15 shows the transmission in a state where the shift fork 102 has been selected and moved in the shifting direction to select a gear of the first gear mechanism, and the shift fork 104 has been selected and moved in a shifting direction opposite to the shifting direction of the shift fork 102 to select a gear of the second gear mechanism.

To ensure that the engaging portion 109 of the shift operating member can move in the selecting direction to engage with the shift fork 102 or the shift fork 104, or engage with another shift fork to select another gear from this state, a shifting direction width L11 of the notches 105, 106, 107, 108 is set such that a shifting direction width L13 of the region in which the notches 105, 106, 107, 108 overlap each other in the selecting direction is larger than a shifting direction width L12 of the engaging portion 109.

However, the transmission of Patent Document 1 is constituted such that when a gear of one of the first gear mechanism and second gear mechanism is selected, the engaging portion 109 can be moved to select another gear at the same time, and therefore the shifting direction width L11 of the notches 105, 106, 107, 108 is set to be considerably larger than the shifting direction width L12 of the engaging portion 109 to ensure that the width L13 is larger than the shifting direction width L12 of the engaging portion 109, as described above.

As a result, the shifting direction dimension of the shift forks 101, 102, 103, 104 increases in length, and sufficient space for accommodating the shift forks 101, 102, 103, 104 is required. Typically, the shifting direction corresponds to the lengthwise direction of the transmission, and therefore, to secure sufficient space for accommodating the shift forks 101, 102, 103, 104 having an enlarged shifting direction dimension, the transmission itself must be increased in length.

Furthermore, the shift forks 101, 102, 103, 104 are moved in the shifting direction by swinging the shift operating member, as described above, but since the shifting direction width L11 of the notches 105, 106, 107, 108 is set to be quite large, the shift operating member must be swung widely such that the movement distance of the engaging portion 109 increases. Moreover, to maintain the engagement between the engaging portion 109 and the notch even when the shift operating member is swung widely in this manner, the up-down direction movement amount of the engaging portion 109 must be reduced by enlarging the swinging radius of the shift operating member, or the height of the notches 105, 106, 107, 108 must be increased.

As a result, the height of the transmission also increases, and when the swinging radius of the shift operating member is increased, the operating force required to operate the shift operating member increases, meaning that the actuator must be increased in size.

### DISCLOSURE OF THE INVENTION

The present invention has been made in consideration of these problems, and it is an object thereof to provide a transmission capable of selecting two gears while suppressing increases in the size of the transmission.

To achieve this object, a transmission of the present invention comprises a plurality of gear change members arranged for moving in a predetermined shifting direction to select a gear of a transmission mechanism; and a shift operating member capable of moving in a selecting direction perpendicular to the shifting direction through notches formed in the gear change members, the shift operating member having an engaging portion capable of engaging with one of the gear change members via the corresponding notch to move the gear change member in the shifting direction, wherein a gap between adjacent gear change members in the selecting direction is larger than a thickness of the engaging portion in the selecting direction (claim 1).

In the transmission constituted in this manner, when an attempt is made to select a desired gear, the engaging portion of the shift operating member is moved in the selecting direction along the notches in the gear change members to the gear change member corresponding to the desired gear, whereupon the engaging portion of the shift operating member is engaged with the notch and moved in the shifting direction. Thus, the desired gear is selected.

When the engaging portion of the shift operating member is moved in the selecting direction while one gear is already selected in this manner, the gap between adjacent gear change members in the selecting direction is larger than the thickness of the engaging portion in the selecting direction, and therefore the engaging portion can be moved in the shifting direction while positioned between the gear change member with which it was engaged upon selection of the desired gear and the gear change member adjacent to this gear change member.

Hence, by moving the engaging portion in the selecting direction through the notches and moving the engaging portion in the shifting direction through the gap between two gear change members, the engaging portion can be engaged with a different gear change member to the gear change member with which it was engaged upon selection of the desired gear and then moved in the shifting direction, whereby a different gear to the desired gear can be selected.

In the transmission described above, a width of the notches in the shifting direction is set to be larger than and similar to a width of the engaging portion in the shifting direction so that the engaging portion can be fitted into one of the notches with play remaining (claim 2).

In the transmission constituted in this manner, the width of the notches in the shifting direction is larger than and similar to the width of the engaging portion in the shifting direction. Therefore, the engaging portion of the shift operating member can move in the selecting direction through the notches and be fitted into one of the notches with play remaining, whereby the gear change members can be moved in the shifting direction.

Furthermore, in the transmission described above, the transmission mechanism comprises a first input shaft to which a driving force from a power source is transmitted via a first clutch; a second input shaft to which the driving force is transmitted via a second clutch; an output shaft arranged for outputting the driving force following speed shifting thereof; a first gear mechanism provided between the first input shaft and the output shaft, and having a plurality of gears; and a second gear mechanism provided between the second input shaft and the output shaft, and having a plurality of gears. The gear change members are constituted by a first gear change member arranged for selecting a gear of the first gear mechanism, and a second gear change member arranged for selecting a gear of the second gear mechanism (claim 3).

In the transmission constituted in this manner, a gear of the first gear mechanism is selected by engaging the engaging portion of the shift operating member with the first gear change member and moving the engaging portion in the shifting direction. Also, a gear of the second gear mechanism is selected by engaging the engaging portion of the shift operating member with the second gear change member and moving the engaging portion in the shifting direction.

When a gear is selected in this manner and the first clutch is engaged, the driving force from the power source is transmitted to the first input shaft via the first clutch, subjected to speed shifting via the selected gear of the first gear mechanism, and then output from the output shaft. At this time, the second clutch is disengaged such that the driving force of the power source is not transmitted to the second input shaft, and therefore driving force transmission from the gear selected in the second gear mechanism to the output shaft is not performed.

When the second clutch is engaged, the driving force from the power source is transmitted to the second input shaft via the second clutch, subjected to speed shifting via the selected gear of the second gear mechanism, and then output from the output shaft. By disengaging the first clutch at this time, the driving force of the power source is prevented from being transmitted to the first input shaft, and therefore driving force transmission from the gear selected in the first gear mechanism to the output shaft is not performed.

In the transmission of the present invention, the gap between adjacent gear change members in the selecting direction is set to be larger than the thickness of the engaging portion of the shift operating member in the selecting direction, and therefore, when one of the gear change members is moved in the shifting direction to select a desired gear and then the engaging portion is moved in the selecting direction, the engaging portion can move in the shifting direction while positioned between the gear change member with which it was engaged upon selection of the desired gear and the gear change member adjacent to this gear change member.

Hence, by moving the engaging portion through the notches in the selecting direction and moving the engaging portion through the gap between the two gear change members in the shifting direction, the engaging portion can be engaged with a different gear change member to the gear change member with which it was engaged upon selection of the desired gear, and then moved in the shifting direction to select a different gear to the desired gear.

As a result, the shifting direction width of the notches does not need to be made considerably larger than the dimension of the engaging portion of the shift operating member which makes it possible for the engaging portion to engage with one of the notches, and the shifting direction dimension of the gear change members can be made comparatively small. Furthermore, the space required to accommodate the gear change members in the shifting direction can be reduced, and therefore increases in the length of the transmission can be prevented.

Moreover, since there is no need to make the shifting direction width of the notches considerably larger than the shifting direction width of the engaging portion, the swinging radius of the shift operating member can be made comparatively small in a case where the shift operating member is swung in order to move the gear change member in the shifting direction using the engaging portion. As a result, increases in the height direction size of the transmission can be prevented, and the operating force required to operate the shift operating member can be reduced, which can downsize the actuator for operating the shift operating member.

Further, in the transmission according to claim 2, the width of the notches in the shifting direction is set to be larger than and similar to the width of the engaging portion in the shifting direction. Therefore, the engaging portion of the shift operating member can be moved in the selecting direction through the notches and fitted into one of the notches with play remaining, whereby the gear change members can be moved in the shifting direction.

As a result, the shifting direction dimension of each gear change member can be suppressed to the required minimum. Moreover, in a case where the shift operating member is swung in order to move the gear change member in the shifting direction using the engaging portion, since the shifting direction play between the engaging portion and the engaged notch of the gear change members is small, the swinging radius of the shift operating member is kept to the required minimum and thereby suppression of the height direction dimension of the transmission can be achieved with maximum effect.

In the transmission according to claim 3, a gear of the first gear mechanism is selected by engaging the engaging portion of the shift operating member with the first gear change member and moving the engaging portion in the shifting direction. Also, a gear of the second gear mechanism is selected by engaging the engaging portion of the shift operating member with the second gear change member and moving the engaging portion in the shifting direction.

Hence, by engaging the first clutch and disengaging the second clutch, the driving force from the power source can be transmitted to the first input shaft via the first clutch, subjected to speed shifting via the selected gear of the first gear mechanism, and then output from the output shaft.

On the other hand, by engaging the second clutch and disengaging the first clutch, the driving force from the power source can be transmitted to the second input shaft via the second clutch, subjected to speed shifting via the selected gear of the second gear mechanism, and then output from the output shaft.

When switching from a gear selected in the first gear mechanism to a gear selected in the second gear mechanism, the second clutch is engaged while disengaging the first clutch such that the driving force can be output from the output shaft continuously, and in so doing, the drivability during a gear change can be improved.

Further, when switching from a gear selected in the second gear mechanism to a gear selected in the first gear mechanism, the first clutch is engaged while disengaging the second clutch such that the driving force can be output from the output shaft continuously, and in so doing, the drivability during a gear change can be improved.

### BRIEF DESCRIPTION OF THE DRAWINGS

FIG. 1 is a skeleton diagram of a transmission according to one embodiment of the present invention;

FIG. 2 is a skeleton diagram of the transmission shown in FIG. 1 when first and second gears are selected and driving force transmission is performed via the first gear;

FIG. 3 is a skeleton diagram of the transmission shown in FIG. 1 when second and third gears are selected and driving force transmission is performed via the second gear;

FIG. 4 is a skeleton diagram of the transmission shown in FIG. 1 when third and fourth gears are selected and driving force transmission is performed via the third gear;

FIG. 5 is a skeleton diagram of the transmission shown in FIG. 1 when fourth and fifth gears are selected and driving force transmission is performed via the fourth gear;

FIG. 6 is a skeleton diagram of the transmission shown in FIG. 1 when fifth and sixth gears are selected and driving force transmission is performed via the fifth gear;

FIG. 7 is a skeleton diagram of the transmission shown in FIG. 1 when fifth and sixth gears are selected and driving force transmission is performed via the sixth gear;

FIG. 8 is a schematic sectional view of a mechanism for selecting a gear by moving various sleeves of a transmission mechanism selectively, seen from the front side of a vehicle;

FIG. 9 is a schematic constitutional diagram showing a first shift rail and the periphery thereof when the mechanism in FIG. 8 is seen from the lateral side of the vehicle;

FIG. 10 is a schematic constitutional diagram showing the first shift rail and the periphery thereof when the mechanism in FIG. 8 is seen from the side of the vehicle;

FIG. 11 is a schematic diagram showing first through fourth shift jaws and an engaging portion of a shift lever when the transmission mechanism is in a neutral state;

FIG. 12 is a schematic diagram showing the first through fourth shift jaws and the engaging portion of the shift lever when the first gear is selected;

FIG. 13 is a schematic diagram showing the first through fourth shift jaws and the engaging portion of the shift lever when the second gear and third gear are selected;

FIG. 14 is a schematic diagram showing shift forks and an engaging portion of a shift operating member in a neutral state in a conventional transmission; and

FIG. 15 is a schematic diagram showing the shift forks and the engaging portion of the shift operating member in the transmission shown in FIG. 14 when two gears are selected.

### BEST MODE OF CARRYING OUT THE INVENTION

A transmission according to one embodiment of the present invention will be described below with reference to the drawings.

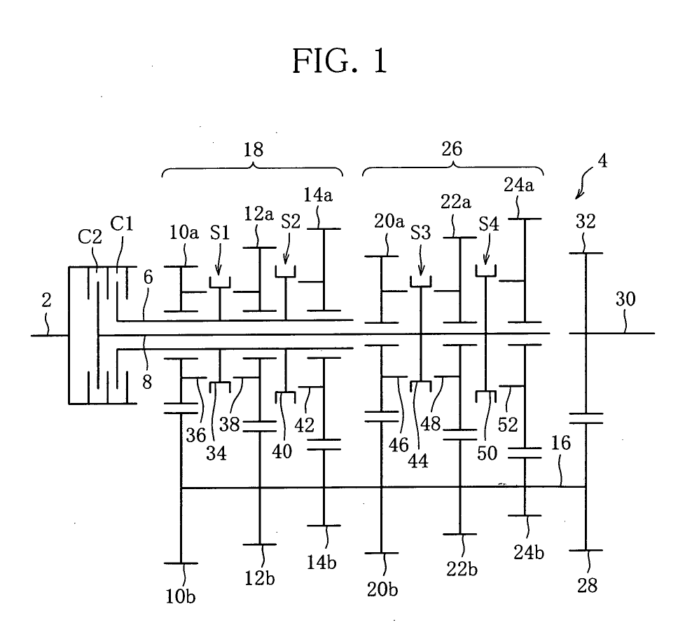

FIG. 1 is a skeleton diagram of a transmission installed in a vehicle. An input side of a first clutch C1 and a second clutch C2 is connected to an output shaft of an engine (not shown) serving as a power source via a shared clutch input shaft 2. Further, an output side of the first clutch C1 is connected to a first input shaft 6 of a transmission mechanism 4, while an output side of the second clutch C2 is connected to a second input shaft 8. The first input shaft 6 is provided coaxially with and on the outside of the second input shaft 8, and the first input shaft 6 and second input shaft 8 are capable of rotating independently of each other.

Further, the first clutch C1 and second clutch C2 are arranged to be engaged and disengaged independently by a clutch actuator, not shown in the drawing.

A first speed drive gear 10a, a third speed drive gear 12a, and a fifth speed drive gear 14a are provided on the first input shaft 6 in this order from the side of the first clutch C1 so as to be capable of rotating relative to the first input shaft 6.

A first speed driven gear 10b that meshes with the first speed drive gear 10a at all times, a third speed driven gear 12b that meshes with the third speed drive gear 12a at all times, and a fifth speed driven gear 14b that meshes with the fifth speed drive gear 14a at all times are fixed to a countershaft 16 disposed parallel with the first input shaft 6 and second input shaft 8, and a first gear mechanism 18 is constituted by the three pairs of drive gears 10a, 12a, 14a and driven gears 10b, 12b, 14b.

Meanwhile, a second speed drive gear 20a, a fourth speed drive gear 22a, and a sixth speed drive gear 24a are provided on the second input shaft 8 in this order from the side of the second clutch C2 so as to be capable of rotating relative to the second input shaft 8.

A second speed driven gear 20b that meshes with the second speed drive gear 20a at all times, a fourth speed driven gear 22b that meshes with the fourth speed drive gear 22a at all times, and a sixth speed driven gear 24b that meshes with the sixth speed drive gear 24a at all times are fixed to the countershaft 16, and a second gear mechanism 26 is constituted by the three pairs of drive gears 20a, 22a, 24a and driven gears 20b, 22b, 24b.

A counter gear 28 is fixed to an end portion of the countershaft 16 on the side of the sixth speed driven gear 24b, and the counter gear 28 always meshes with an output gear 32 fixed to an output shaft 30 of the transmission mechanism 4, whereby the driving force of the countershaft 16 is transmitted to the output shaft 30. The driving force output from the output shaft 30 is transmitted to drive wheels, not shown in the drawing, thereby causing the vehicle to travel.

Note that the transmission mechanism 4 also has a reverse gear mechanism for causing the vehicle to reverse, but here, for the sake of simplicity, illustration and description of the reverse gear mechanism have been omitted.

In the first gear mechanism 18, a first synchromesh device S1 that rotates integrally with the first input shaft 6 is disposed between the first speed drive gear 10a and the third speed drive gear 12a, and a second synchromesh device S2 that rotates integrally with the first input shaft 6 is disposed between the third speed drive gear 12a and the fifth speed drive gear 14a.

The first synchromesh device S1 has a first sleeve 34 which is capable of sliding in an axial direction of the first input shaft 6, and when the first sleeve 34 moves to the side of the first speed drive gear 10a to engage with a first speed clutch gear 36 fixed to the first speed drive gear 10a, the first speed drive gear 10a is connected to the first input shaft 6 such that a first gear is selected.

On the other hand, when the first sleeve 34 moves to the side of the third speed drive gear 12a to engage with a third speed clutch gear 38 fixed to the third speed drive gear 12a, the third speed drive gear 12a is connected to the first input shaft 6 such that a third gear is selected.

Further, the second synchromesh device S2 has a second sleeve 40 which is capable of sliding in the axial direction of the first input shaft 6, and when the second sleeve 40 moves to the side of the fifth speed drive gear 14a to engage with a fifth speed clutch gear 42 fixed to the fifth speed drive gear 14a, the fifth speed drive gear 14a is connected to the first input shaft 6 such that a fifth gear is selected.

In the second gear mechanism 26, a third synchromesh device S3 that rotates integrally with the second input shaft 8 is disposed between the second speed drive gear 20a and the fourth speed drive gear 22a, and a fourth synchromesh device S4 that rotates integrally with the second input shaft 8 is disposed between the fourth speed drive gear 22a and the sixth speed drive gear 24a.

The third synchromesh device S3 has a third sleeve 44 which is capable of sliding in an axial direction of the second input shaft 8, and when the third sleeve 44 moves to the side of the second speed drive gear 20a to engage with a second speed clutch gear 46 fixed to the second speed drive gear 20a, the second speed drive gear 20a is connected to the second input shaft 8 such that a second gear is selected.

On the other hand, when the third sleeve 44 moves to the side of the fourth speed drive gear 22a to engage with a fourth speed clutch gear 48 fixed to the fourth speed drive gear 22a, the fourth speed drive gear 22a is connected to the second input shaft 8 such that a fourth gear is selected.

Further, the fourth synchromesh device S4 has a fourth sleeve 50 which is capable of sliding in the axial direction of the second input shaft 8, and when the fourth sleeve 50 moves to the side of the sixth speed drive gear 24a to engage with a sixth speed clutch gear 52 fixed to the sixth speed drive gear 24a, the sixth speed drive gear 24a is connected to the second input shaft 8 such that a sixth gear is selected.

A gear is selected by moving the sleeves provided respectively in the synchromesh devices S1, S2, S3, S4 in this manner. The driving force of the engine is transmitted to the first gear mechanism 18 via the first clutch C1, and the driving force of the engine is transmitted to the second gear mechanism 26 via the second clutch C2. Hence, by engaging the first clutch C1 and disengaging the second clutch C2, for example, one of the gears can be selected in the second gear mechanism 26 while outputting driving force to the output shaft 30 via one of the gears which has been selected in the first gear mechanism 18.

Further, by disengaging the first clutch C1 and engaging the second clutch C2, one of the gears can be selected in the first gear mechanism 18 while outputting driving force to the output shaft 30 via one of the gears which has been selected in the second gear mechanism 26.

Hence, in advance of performing a gear change, the predicted gear of the next gear change is selected in the gear mechanism to which the driving force of the engine is not being transmitted at the present time, from among the first gear mechanism 18 and second gear mechanism 26. Subsequently, when a gear change request is issued, the disengaged clutch, from among the first clutch C1 and second clutch C2, is engaged while disengaging the other clutch which has been engaged, and thus driving force can be output from the output shaft 30 continuously, even during a gear change. As a result, the drivability during the gear change can be improved.

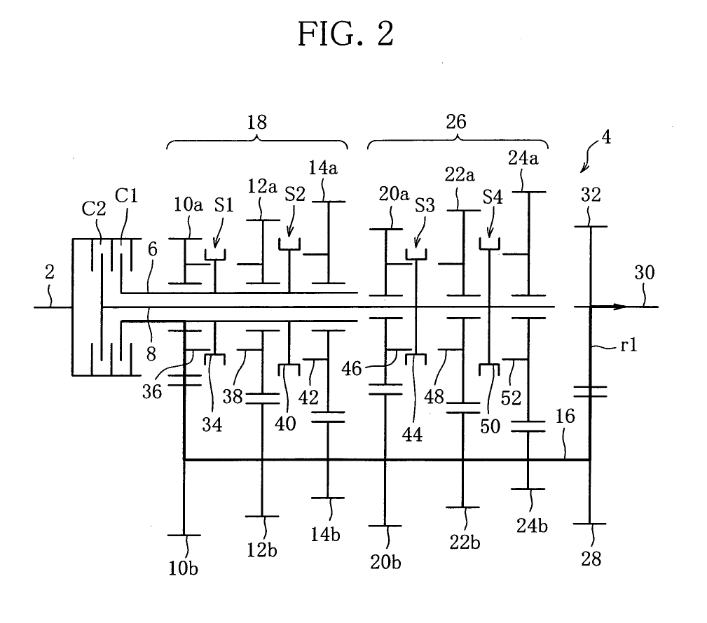

Note that FIG. 1 shows a neutral state in which all of the sleeves are in a neutral position, i.e. not engaged with the clutch gears, and no gear is selected in the transmission mechanism 4. Specific examples of gear combinations in the first gear mechanism 18 and second gear mechanism 26 in states other than the neutral state will now be described on the basis of FIGS. 2 through 7.

FIGS. 2 through 7 show gear selection states in phases when the vehicle starts traveling with the first gear and accelerates.

FIG. 2 shows a state in which the vehicle starts traveling with first gear and accelerates. The first clutch C1 is engaged such that the driving force of the engine is transmitted to the first input shaft 6 via the first clutch C1. Meanwhile, the second clutch C2 is disengaged such that the driving force of the engine is not transmitted to the second input shaft 8.

At this time, in the first gear mechanism 18, the first sleeve 34 of the first synchromesh device S1 moves to the side of the first speed drive gear 10a to engage with the first speed clutch gear 36, and as a result, the first speed drive gear 10a is connected to the first input shaft 6 such that the first gear is selected. Hence, as shown by an arrow r1 in FIG. 2, the driving force that is transmitted from the engine to the first input shaft 6 is shifted in speed by the first gear, which is constituted by the first speed drive gear 10a and the first speed driven gear 10b, and then transmitted to the output shaft 30 via the output gear 32 that meshes with the counter gear 28.

Meanwhile, in the second gear mechanism 26, it is predicted that the second gear will be used after the first gear, and therefore the third sleeve 44 of the third synchromesh device S3 is moved to the side of the second speed drive gear 20a to engage with the second speed clutch gear 46, whereby the second speed drive gear 20a is connected to the second input shaft 8 such that the second gear is selected. At this time, the countershaft 16 is rotated by the driving force of the engine, which is transmitted thereto via the first gear, and since the second clutch C2 is disengaged, the driving force of the engine is not transmitted to the second input shaft 8. Hence, the rotation of the countershaft 16 is transmitted to the second input shaft 8 from the second speed driven gear 20b via the second speed drive gear 20a, and as a result, the second input shaft 8 rotates idly.

By pre-selecting the second gear in the second gear mechanism 26 while the driving force is shifted in speed by the first gear in the first gear mechanism 18 and then output to the output shaft 30, shifting from the first gear to the second gear can be performed quickly and smoothly by engaging the second clutch C2 while disengaging the first clutch C1 when a request for a gear change to the second gear is actually issued as the vehicle accelerates, and hence the driving force can be output from the output shaft 30 continuously. As a result, the drivability during the gear change can be improved.

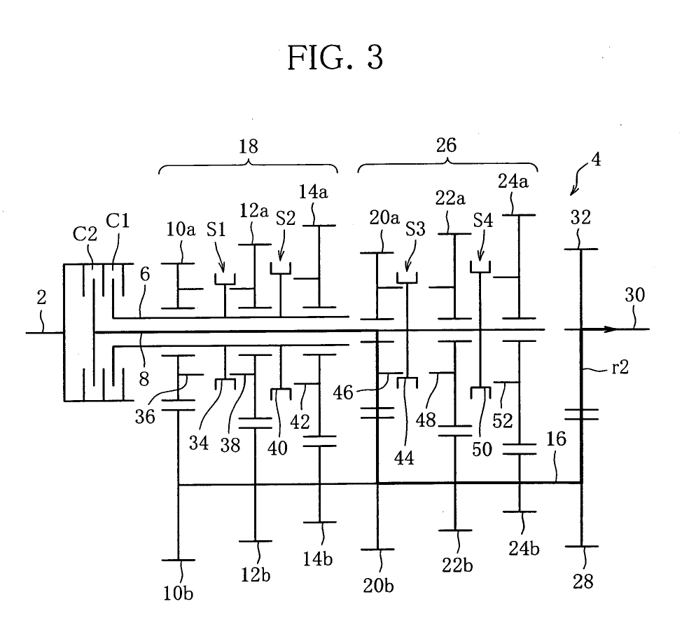

When the first clutch C1 is disengaged and the second clutch C2 is engaged in the state where the first gear is selected in the first gear mechanism 18 and the second gear is selected in the second gear mechanism 26 in this manner, the driving force transmitted from the engine to the second input shaft 8 via the second clutch C2 is shifted in speed by the second gear, which is constituted by the second speed drive gear 20a and the second speed driven gear 20b, and then transmitted to the output shaft 30 via the output gear 32 that meshes with the counter gear 28, as shown by an arrow r2 in FIG. 3.

Meanwhile, the driving force of the engine is no longer transmitted to the first gear mechanism 18, and therefore, in the first gear mechanism 18, the third gear is predicted to be the gear that will be selected next. Hence, as shown in FIG. 3, the first sleeve 34 of the first synchromesh device S1 is moved to the side of the third speed drive gear 12a to engage with the third speed clutch gear 38, whereby the third speed drive gear 12a is connected to the first input shaft 6 such that the third gear is selected.

At this time, the countershaft 16 is rotated by the driving force of the engine, which is transmitted thereto via the second gear, and since the first clutch C1 is disengaged, the driving force of the engine is not transmitted to the first input shaft 6. Hence, the rotation of the countershaft 16 is transmitted to the first input shaft 6 from the third speed driven gear 12b via the third speed drive gear 12a, and as a result, the first input shaft 6 rotates idly.

By pre-selecting the third gear in the first gear mechanism 18 while the driving force is shifted in speed by the second gear in the second gear mechanism 26 and then output to the output shaft 30, shifting from the second gear to the third gear can be performed quickly and smoothly by engaging the first clutch C1 while disengaging the second clutch C2 when a request for a gear change to the third gear is actually issued as the vehicle accelerates, and hence the driving force can be output from the output shaft 30 continuously. As a result, the drivability during the gear change can be improved.

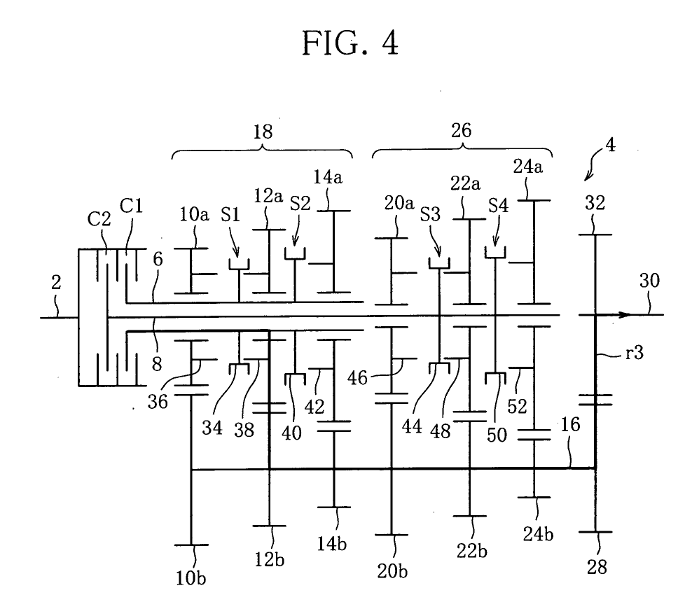

Further, when the first clutch C1 is engaged and the second clutch C2 is disengaged in the state where the third gear is selected in the first gear mechanism 18 and the second gear is selected in the second gear mechanism 26 in this manner, the driving force transmitted from the engine to the first input shaft 6 via the first clutch C1 is shifted in speed by the third gear, which is constituted by the third speed drive gear 12a and the third speed driven gear 12b, and then transmitted to the output shaft 30 via the output gear 32 that meshes with the counter gear 28, as shown by an arrow r3 in FIG. 4.

Meanwhile, the driving force of the engine is no longer transmitted to the second gear mechanism 26, and therefore, in the second gear mechanism 26, the fourth gear is predicted to be the gear that will be selected next. Hence, as shown in FIG. 4, the third sleeve 44 of the third synchromesh device S3 is moved to the side of the fourth speed drive gear 22a to engage with the fourth speed clutch gear 48, whereby the fourth speed drive gear 22a is connected to the second input shaft 8 such that the fourth gear is selected.

At this time, the countershaft 16 is rotated by the driving force of the engine, which is transmitted thereto via the third gear, and since the second clutch C2 is disengaged, the driving force of the engine is not transmitted to the second input shaft 8. Hence, the rotation of the countershaft 16 is transmitted to the second input shaft 8 from the fourth speed driven gear 22b via the fourth speed drive gear 22a, and as a result, the second input shaft 8 rotates idly.

By pre-selecting the fourth gear in the second gear mechanism 26 while the driving force is shifted in speed by the third gear in the first gear mechanism 18 and then output to the output shaft 30, shifting from the third gear to the fourth gear can be performed quickly and smoothly by engaging the second clutch C2 while disengaging the first clutch C1 when a request for a gear change to the fourth gear is actually issued as the vehicle accelerates, and hence the driving force can be output from the output shaft 30 continuously. As a result, the drivability during the gear change can be improved.

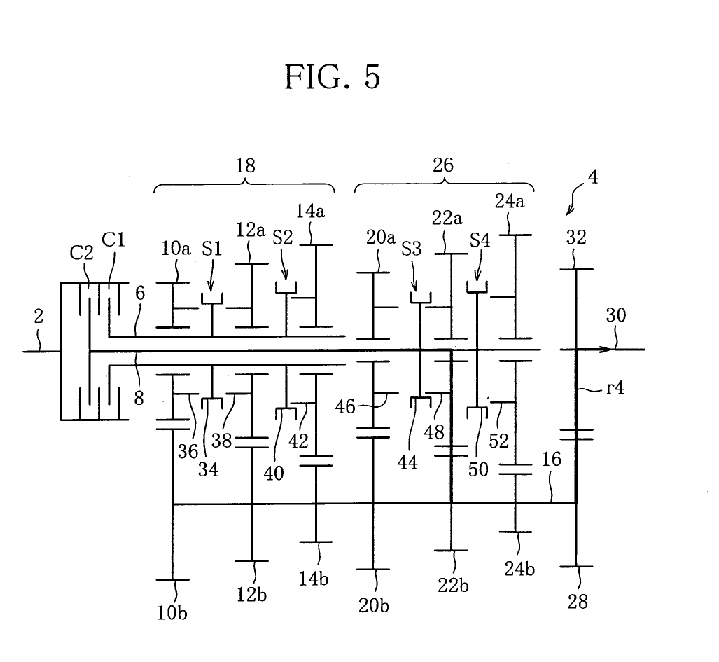

Next, when the first clutch C1 is disengaged and the second clutch C2 is engaged in the state where the third gear is selected in the first gear mechanism 18 and the fourth gear is selected in the second gear mechanism 26 in this manner, the driving force transmitted from the engine to the second input shaft 8 via the second clutch C2 is shifted in speed by the fourth gear, which is constituted by the fourth speed drive gear 22a and the fourth speed driven gear 22b, and then transmitted to the output shaft 30 via the output gear 32 that meshes with the counter gear 28, as shown by an arrow r4 in FIG. 5.

Meanwhile, the driving force of the engine is no longer transmitted to the first gear mechanism 18, and therefore, in the first gear mechanism 18, the fifth gear is predicted to be the gear that will be selected next. Hence, as shown in FIG. 5, the first sleeve 34 of the first synchromesh device S1 is set in a neutral position engaged with neither the first speed clutch gear 36 nor the third speed clutch gear 38, and the second sleeve 40 of the second synchromesh device S2 is moved to the side of the fifth speed drive gear 14a to engage with the fifth speed clutch gear 42. As a result, the fifth speed drive gear 14a is connected to the first input shaft 6, and the fifth gear is selected.

At this time, the countershaft 16 is rotated by the driving force of the engine, which is transmitted thereto via the fourth gear, and since the first clutch C1 is disengaged, the driving force of the engine is not transmitted to the first input shaft 6. Hence, the rotation of the countershaft 16 is transmitted to the first input shaft 6 from the fifth speed driven gear 14b via the fifth speed drive gear 14a, and as a result, the first input shaft 6 rotates idly.

By pre-selecting the fifth gear in the first gear mechanism 18 while the driving force is shifted in speed by the fourth gear in the second gear mechanism 26 and then output to the output shaft 30, shifting from the fourth gear to the fifth gear can be performed quickly and smoothly by engaging the first clutch C1 while disengaging the second clutch C2 when a request for a gear change to the fifth gear is actually issued as the vehicle accelerates, and hence the driving force can be output from the output shaft 30 continuously. As a result, the drivability during the gear change can be improved.

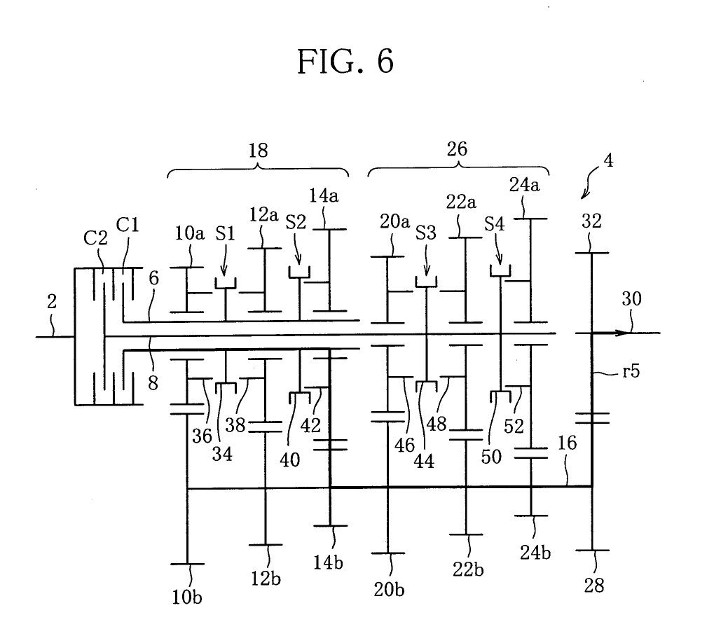

Next, when the first clutch C1 is engaged and the second clutch C2 is disengaged in the state where the fifth gear is selected in the first gear mechanism 18 and the fourth gear is selected in the second gear mechanism 26 in this manner, the driving force transmitted from the engine to the first input shaft 6 via the first clutch C1 is shifted in speed by the fifth gear, which is constituted by the fifth speed drive gear 14a and the fifth speed driven gear 14b, and then transmitted to the output shaft 30 via the output gear 32 that meshes with the counter gear 28, as shown by an arrow r5 in FIG. 6.

Meanwhile, the driving force of the engine is no longer transmitted to the second gear mechanism 26, and therefore, in the second gear mechanism 26, the sixth gear is predicted to be the gear that will be selected next. Hence, as shown in FIG. 6, the third sleeve 44 of the third synchromesh device S3 is set in a neutral position engaged with neither the second speed clutch gear 46 nor the fourth speed clutch gear 48, and the fourth sleeve 50 of the fourth synchromesh device S4 is moved to the side of the sixth speed drive gear 24a to engage with the sixth speed clutch gear 52, whereby the sixth speed drive gear 24a is connected to the second input shaft 8 and the sixth gear is selected.

At this time, the countershaft 16 is rotated by the driving force of the engine, which is transmitted thereto via the fifth gear, and since the second clutch C2 is disengaged, the driving force of the engine is not transmitted to the second input shaft 8. Hence, the rotation of the countershaft 16 is transmitted to the second input shaft 8 from the sixth speed driven gear 24b via the sixth speed drive gear 24a, and as a result, the second input shaft 8 rotates idly.

By pre-selecting the sixth gear in the second gear mechanism 26 while the driving force is shifted in speed by the fifth gear in the first gear mechanism 18 and then output to the output shaft 30, shifting from the fifth gear to the sixth gear can be performed quickly and smoothly by engaging the second clutch C2 while disengaging the first clutch C1 when a request for a gear change to the sixth gear is actually issued as the vehicle accelerates, and hence the driving force can be output from the output shaft 30 continuously. As a result, the drivability during the gear change can be improved.

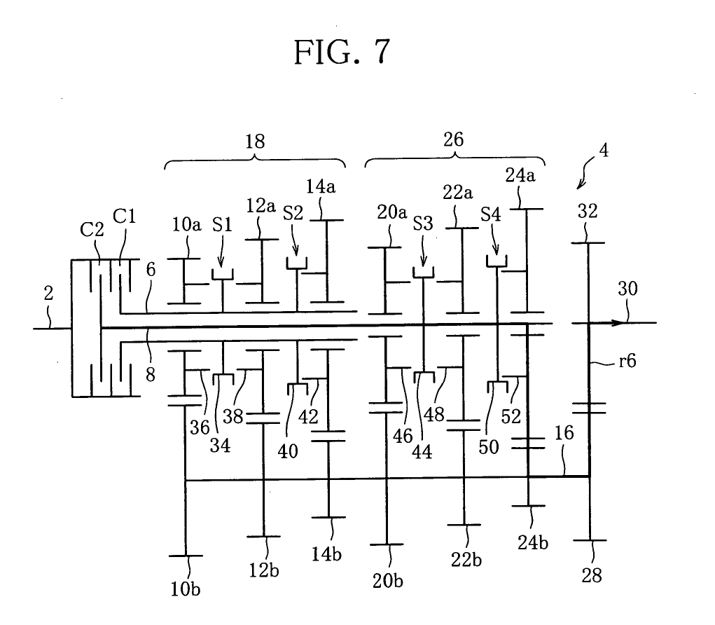

Further, when the first clutch C1 is disengaged and the second clutch C2 is engaged in the state where the fifth gear is selected in the first gear mechanism 18 and the sixth gear is selected in the second gear mechanism 26 in this manner, the driving force transmitted from the engine to the second input shaft 8 via the second clutch C2 is shifted in speed by the sixth gear, which is constituted by the sixth speed drive gear 24a and the sixth speed driven gear 24b, and then transmitted to the output shaft 30 via the output gear 32 that meshes with the counter gear 28, as shown by an arrow r6 in FIG. 7.

The sixth gear selected at this time is the highest gear, and therefore, even if the vehicle continues to accelerate, a gear change to a higher gear is not performed, and the next gear change is assumed to be a change to the fifth gear accompanying deceleration of the vehicle or the like. Hence, in the first gear mechanism 18, to which the driving force of the engine is not transmitted, the fifth gear is predicted to be the gear that will be selected next, and by keeping the third sleeve 40 engaged with the fifth speed clutch gear 42, as shown in FIG. 7, the fifth speed drive gear 14a continues to be connected to the first input shaft 6 such that the fifth gear continues to be selected.

At this time, the countershaft 16 is rotated by the driving force of the engine, which is transmitted thereto via the sixth gear, and since the first clutch C1 is disengaged, the driving force of the engine is not transmitted to the first input shaft 6. Hence, the rotation of the countershaft 16 is transmitted to the first input shaft 6 from the fifth speed driven gear 14b via the fifth speed drive gear 14a, and as a result, the first input shaft 6 rotates idly.

By pre-selecting the fifth gear in the first gear mechanism 18 while the driving force is shifted in speed by the sixth gear in the second gear mechanism 26 and then output to the output shaft 30, shifting from the sixth gear to the fifth gear can be performed quickly and smoothly by engaging the first clutch C1 while disengaging the second clutch C2 when a request for a gear change to the fifth gear is actually issued, and hence the drivability during the gear change can be improved.

A specific example of gear selection when the vehicle starts up with first gear and accelerates has been described above. However, gear changes other than those described above are performed in a similar manner, and by engaging one of the first clutch C1 and second clutch C2 and disengaging the other while corresponding gears in the first gear mechanism 18 and second gear mechanism 26 are selected respectively, these gear changes are performed quickly and smoothly.

Next, a mechanism for moving the first through fourth sleeves 34, 40, 44, 50 of the transmission mechanism 4 selectively when selecting a gear will be described.

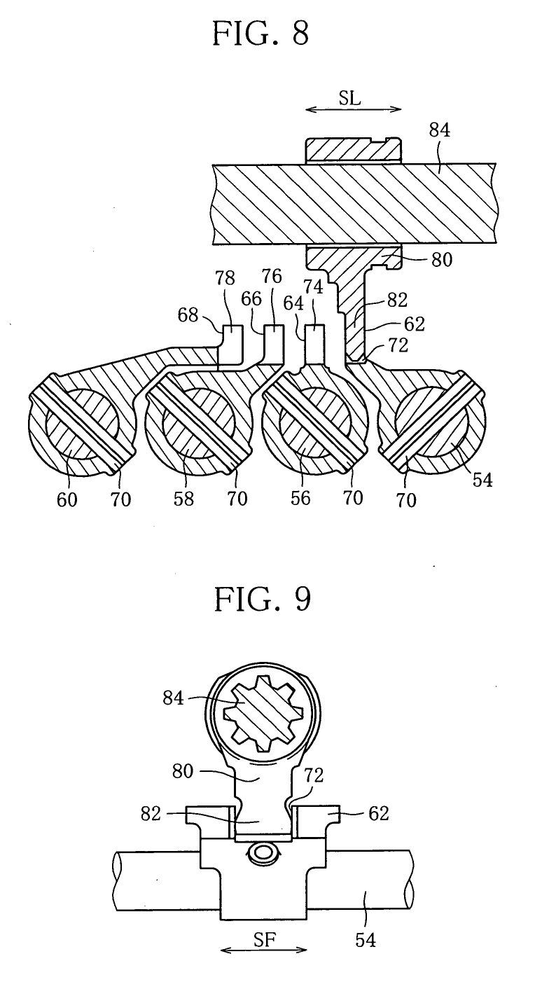

The transmission shown in FIG. 1 is installed in the vehicle with the side of the clutch input shaft 2 being directed toward the front side of the vehicle such that the axial direction of the first input shaft 6 and second input shaft 8 corresponds to the front-rear direction of the vehicle. FIG. 8 is a schematic sectional view showing a mechanism for moving the first through fourth sleeves 34, 40, 44, 50 selectively, seen from the front of the vehicle.

As shown in FIG. 8, a first shift rail 54, a second shift rail 56, a third shift rail 58, and a fourth shift rail 60 are disposed parallel to each other in the axial direction of the first input shaft 6 and second input shaft 8.

The first shift rail 54 is connected to the first sleeve 34 of the first synchromesh device S1, and by moving the first shift rail 54 to the front side of the vehicle in the axial direction of the first input shaft 6 and second input shaft 8, i.e. the shifting direction, from the neutral position, the first sleeve 34 is engaged with the first speed clutch gear 36 of the first speed drive gear 10a, whereby the first gear is selected.

On the other hand, when the first shift rail 54 is moved to the rear side of the vehicle in the shifting direction from the neutral position, the first sleeve 34 is engaged with the third speed clutch gear 38 of the third speed drive gear 12a, whereby the third gear is selected.

The second shift rail 56 is connected to the second sleeve 40 of the second synchromesh device S2, and by moving the second shift rail 56 to the rear side of the vehicle in the shifting direction from the neutral position, the second sleeve 40 is engaged with the fifth speed clutch gear 42 of the fifth speed drive gear 14a, whereby the fifth gear is selected.

Further, the third shift rail 58 is connected to the third sleeve 44 of the third synchromesh device S3, and by moving the third shift rail 58 to the front side of the vehicle in the shifting direction from the neutral position, the third sleeve 44 is engaged with the second speed clutch gear 46 of the second speed drive gear 20a, whereby the second gear is selected. On the other hand, when the third shift rail 58 is moved to the rear side of the vehicle in the shifting direction from the neutral position, the third sleeve 44 is engaged with the fourth speed clutch gear 48 of the fourth speed drive gear 22a, whereby the fourth gear is selected.

The fourth shift rail 60 is connected to the fourth sleeve 50 of the fourth synchromesh device S4, and by moving the fourth shift rail 60 to the rear side of the vehicle in the shifting direction from the neutral position, the fourth sleeve 50 is engaged with the sixth speed clutch gear 52 of the sixth speed drive gear 24a, whereby the sixth gear is selected.

As shown in FIG. 8, first through fourth shift jaws 62, 64, 66, 68 are disposed close to each other on the first through fourth shift rails 54, 56, 58, 60, respectively, and each fixed by a pin 70. The first through fourth shift rails 54, 56, 58, 60 and first through fourth shift jaws 62, 64, 66, 68 constitute gear change members of the present invention. Further, the first and second shift rails 54, 56 and the first and second shift jaws 62, 64 correspond to a first gear change member of the present invention, while the third and fourth shift rails 58, 60 and the third and fourth shift jaws 66, 68 correspond to a second gear change member of the present invention.

FIG. 9 is a view showing the first shift rail 54 and the peripheral constitution thereof, seen from the lateral side of the vehicle, or in other words the right side of FIG. 8. As shown in FIG. 9, a U-shaped notch 72 is formed in the first shift jaw 62 and has a width that allows an engaging portion 82 formed on a lower end of a shift lever (shift operating member) 80 to be fitted into the notch 72 with play remaining.

Similar notches 74, 76, 78 are formed in the second through fourth shift jaws 64, 66, 68, respectively, and each of the notches 74, 76, 78 has a width that allows the engaging portion 82 of the shift lever 80 to be fitted into each of the notches 74, 76, 78 with play remaining.

A select shaft 84 is disposed above the first through fourth shift rails 54, 56, 58, 60 in such a manner that an axis thereof is oriented in a direction perpendicular to the respective axes of the first through fourth shift rails 54, 56, 58, 60, and the shift lever 80 is mounted to the select shaft 84 with spline-fitting. Thus, the shift lever 80 is capable of sliding in the axial direction of the select shaft 84, and rotation thereof relative to the select shaft 84 about the axis of the select shaft 84 is restricted. By moving the shift lever 80 in the axial direction of the select shaft 84, the engaging portion 82 is moved in a selecting direction (indicated by an arrow SL in FIG. 8) perpendicular to the shifting direction so that the engaging portion 82 can be engaged selectively with one of the notches 72, 74, 76, 78.

Further, the select shaft 84 is capable of rotating about its axis, and when the select shaft 84 rotates, the shift lever 80 swings about the axial center of the select shaft 84.

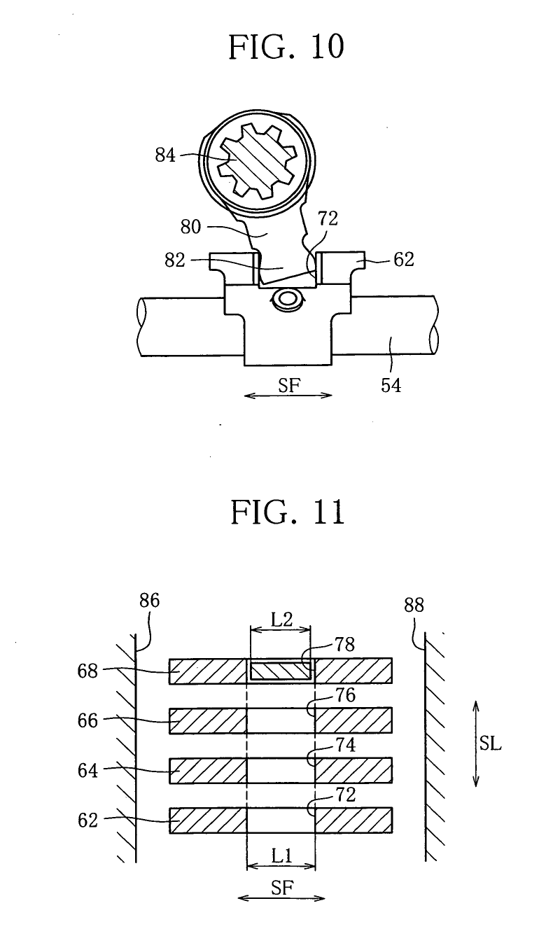

Hence, for example, when the shift lever 80 moves in the selecting direction indicated by the arrow SL so as to engage with the notch 72 of the first jaw 62 with play remaining, and then the select shaft 84 rotates such that the shift lever 80 swings to the rear side of the vehicle in the shifting direction indicated by the arrow SF in FIG. 9, the engaging portion 82 causes the first shift jaw 62 and the first shift rail 54 fixed to the first shift jaw 62 to move to the rear side of the vehicle in the shifting direction, as shown in FIG. 10. As a result, the first sleeve 34 of the first synchromesh device S1 is moved toward the third speed drive gear 12a to engage with the third speed clutch gear 38, as described above, and thus the third gear is selected.

On the other hand, when the shift lever 80 engages with the notch 72 of the first jaw 62 with play remaining and then the select shaft 84 rotates such that the shift lever 80 swings to the front side of the vehicle in the shifting direction, the engaging portion 82 causes the first shift jaw 62 and first shift rail 54 to move to the front side of the vehicle in the shifting direction. As a result, the first sleeve 34 of the first synchromesh device S1 is moved toward the first speed drive gear 10a to engage with the first speed clutch gear 36, as described above, and thus the first gear is selected.

Thus, when the shift lever 80 moves in the selecting direction such that the engaging portion 82 engages with one of the notches 72, 74, 76, 78 with play remaining, and then the select shaft 84 rotates such that the shift lever 80 swings in the shifting direction, the shift jaw with which the engaging portion 82 is engaged is moved in the shifting direction, and as a result, the corresponding gear is selected.

Note that movement of the shift lever 80 in the selecting direction and rotation of the select shaft 84 about its axis are executed by shift actuators, not shown in the drawing, which are operated in accordance with shift control performed by a controller, not shown in the drawing.

Next, an operation of this mechanism performed during gear selection will be described on the basis of FIGS. 11 through 13.

FIG. 11 is a schematic diagram showing the first through fourth shift jaws 62, 64, 66, 68 and the engaging portion 82 of the shift lever 80 when the transmission mechanism 4 is in the neutral state.

By moving the first through fourth shift jaws 62, 64, 66, 68 into contact with either one of stoppers 86 and 88 in the shifting direction, which is indicated by the arrow SF in the drawing, a gear can be selected in the manner described above. In the neutral state, the first through fourth shift jaws 62, 64, 66, 68 are set at a middle position between the stoppers 86 and 88, as shown in FIG. 11.

Further, a shifting direction width L1 of the respective notches 72, 74, 76, 78 formed in the first through fourth shift jaws 62, 64, 66, 68 is similar to, but slightly larger than, a shifting direction width L2 of the engaging portion 82 of the shift lever 80 so that the engaging portion 82 can be fitted into one of the notches 72, 74, 76, 78 with play remaining, as described above.

Hence, the engaging portion 82 of the shift lever 80 is capable of moving in the selecting direction, which is indicated by the arrow SL in the drawing, through the notches 72, 74, 76, 78, and also capable of moving in the shifting direction as the shift lever 80 swings.

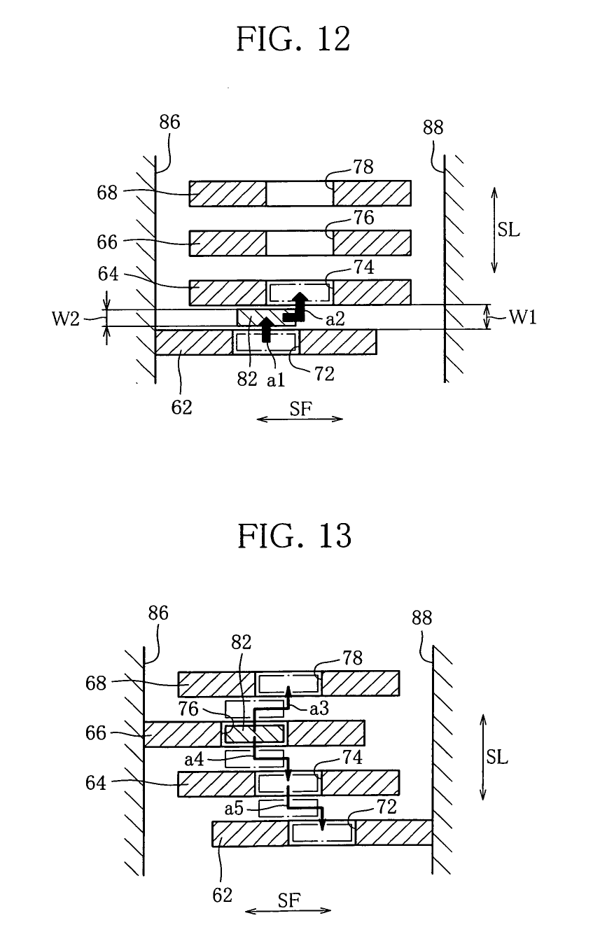

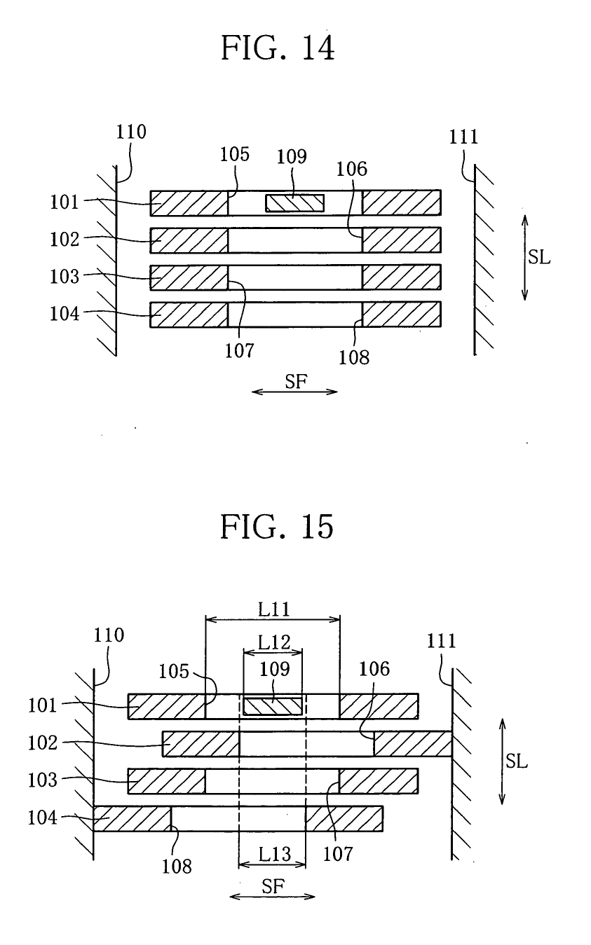

FIG. 12 shows an example in which the first gear is selected by engaging the engaging portion 82 of the shift lever 80 with the notch 72 of the first shift jaw 62 and then swinging the shift lever 80 to the front side of the vehicle in the shifting direction until the first shift jaw 62 contacts with the stopper 86. From this state, the engaging portion 82 moves in the direction of an arrow a1 in the selecting direction so as to be positioned between the first shift jaw 62 and the second shift jaw 64.

As shown in FIG. 12, a gap W1 between the first shift jaw 62 and second shift jaw 64 is set to be larger than a selecting direction thickness W2 of the engaging portion 82 so that the engaging portion 82 can move in the shifting direction between the first shift jaw 62 and second shift jaw 64. Hence, as shown in FIG. 12, even when the first shift jaw 62 is in contact with the stopper 86, the engaging portion 82 can be moved into the notch 74 of the second shift jaw 64 by moving the engaging portion 82 in the direction of the arrow a1 in the selecting direction from the notch 72 of the first shift jaw 62, then moving the engaging portion 82 to the rear side of the vehicle in the shifting direction, as shown by an arrow a2, and then moving the engaging portion 82 in the selecting direction again.

The gap between the second shift jaw 64 and third shift jaw 66 and the gap between the third shift jaw 66 and fourth shift jaw 68 are also set at W1, which is larger than the thickness W2 of the engaging portion 82 in the selecting direction, and therefore the engaging portion 82 is also capable of moving in the shifting direction between the second shift jaw 64 and third shift jaw 66 and between the third shift jaw 66 and fourth shift jaw 68.

Hence, even when one of the first through fourth shift jaws 62, 64, 66, 68 moves to the side of the stopper 86 and one of the other shift jaws moves to the side of the stopper 88, the engaging portion 82 can be moved freely to the required position.

For example, FIG. 13 shows a state in which the third gear is selected by moving the first shift jaw 62 in the shifting direction until it contacts with the stopper 88, the second gear is selected by moving the third shift jaw 66 in the shifting direction until it contacts with the stopper 86, and the engaging portion 82 of the shift lever 80 is positioned inside the notch 76 of the third shift jaw 66.

As shown by arrows a3, a4, a5 in the drawing, even in this state, the engaging portion 82 can be moved through the gaps between adjacent shift jaws and the notches in each shift jaw, and thus the engaging portion 82 can be moved freely to the corresponding shift jaw for selecting the desired gear.

Hence, in a state such as that shown in FIG. 13, for example, the shifting direction width of the notches 72, 74, 76, 78 does not have to be increased such that the shifting direction width of the region in which the notches 72, 74, 76, 78 overlap each other in the selecting direction is larger than the shifting direction width of the engaging portion 82, and therefore the first through fourth shift jaws 62, 64, 66, 68 can be made compact in the shifting direction.

Further, by making the first through fourth shift jaws 62, 64, 66, 68 compact in the shifting direction, the gap between the stopper 86 and the stopper 88 can be shortened, enabling a reduction in the space required to accommodate the first through fourth shift jaws 62, 64, 66, 68 in the front-rear direction of the vehicle and a reduction in the dimension of the transmission mechanism 4 in the axial direction of the first input shaft 6 and second input shaft 8.

Note that by making the selecting direction gap W1 between the first through fourth shift jaws 62, 64, 66, 68 larger than the selecting direction thickness W2 of the engaging portion 82, the selecting direction width from the first shift jaw 62 to the fourth shift jaw 68 increases. However, as shown in FIG. 8, the selecting direction width from the first shift jaw 62 to the fourth shift jaw 68 is much smaller than the selecting direction width from the first shift rail 54 to the fourth shift rail 60, and hence there is substantially no change in the space required to accommodate the first through fourth shift jaws 62, 64, 66, 68 in the vehicle width direction and substantially no effect on the dimension of the transmission mechanism 4 in a perpendicular direction to the axis of the first input shaft 6 and second input shaft 8.

Further, the shifting direction width L1 of the notches 72, 74, 76, 78 formed in the first through fourth shift jaws 62, 64, 66, 68 is set to be similar to, but only slightly larger than, the shifting direction width L2 of the engaging portion 82 so that the engaging portion 82 can be fitted into one of the notches 72, 74, 76, 78 with play remaining, as described above, and therefore the amount of play between the engaging portion 82 and engaged one of the notches 72, 74, 76, 78 can be kept to the required minimum.

Hence, the engagement between the engaging portion 82 and one of the notches 72, 74, 76, 78 can be maintained when the corresponding one of the first through fourth shift jaws 62, 64, 66, 68 is moved into contact with the stopper 86 or the stopper 88 without increasing the swinging radius of the shift lever 80. As a result, the space required to accommodate the shift lever 80, the select shaft 84, and so on in the height direction of the transmission can also be made comparatively small.

Further, by reducing the swinging radius of the shift lever 80, the operating force required to operate the shift lever 80 can be reduced, and an actuator for causing the shift lever 80 to swing via the select shaft 84 can be downsized.

By reducing the operating force required to operate the shift lever 80, the strength of the engaging portion 82 and the first through fourth shift jaws 62, 64, 66, 68 can be reduced, and the thickness of the engaging portion 82 and the first through fourth shift jaws 62, 64, 66, 68 in the selecting direction can be reduced.

As a result, the increase in the selecting direction width from the first shift jaw 62 to the fourth shift jaw 68 that occurs as a result of making the gap W1 between the first through fourth shift jaws 62, 64, 66, 68 larger than the selecting direction thickness W2 of the engaging portion 82 can be absorbed.

The transmission according to one embodiment of the present invention has been described above. However, the present invention is not limited to the embodiment described above.

For example, in the embodiment described above, the transmission, in which the driving force of the engine can be transmitted to the first gear mechanism 18 via the first clutch C1 and to the second gear mechanism 26 via the second clutch C2, is constituted such that a gear of the first gear mechanism 18 and a gear of the second gear mechanism 26 are selected simultaneously, but the number and constitution of the clutches and the number and constitution of the gear mechanisms are not limited to those described above, and the present invention may be applied to any transmission in which, at least, a gear can be selected by moving a gear change member while a shift operating member is engaged with the gear change member, and a plurality of gears can be selected at the same time.

Accordingly, in a transmission such as that described in the above embodiment, the number of gears is not limited to six, and the present invention can be applied similarly to a transmission having a smaller or larger number of gears as required. Moreover, the combinations of gears and synchromesh devices and the arrangement of the shift jaws may be modified appropriately.

Further, in the embodiment described above, the first input shaft 6 and second input shaft 8 are disposed coaxially, but the two input shafts may be disposed separately so as to be parallel with each other.

Furthermore, in the embodiment described above, the first gear mechanism 18 is formed between the first input shaft 6 and the countershaft 16, the second gear mechanism 26 is formed between the second input shaft 8 and the countershaft 16, and the driving force transmitted to the countershaft 16 is output to the output shaft 30 via the output gear 32 that meshes with the counter gear 28. However, a plurality of countershafts may be provided, for example.

Further, in the embodiment described above, the effects of the present invention are maximized by making the shifting direction width L1 of the notches 72, 74, 76, 78 formed in the first through fourth shift jaws 62, 64, 66, 68 similar to, but slightly larger than, the shifting direction width L2 of the engaging portion 82 so that the engaging portion 82 can be fitted into the notches 72, 74, 76, 78 with play remaining. However, if there is surplus space in the shifting direction, the shifting direction width L1 of the notches 72, 74, 76, 78 does not necessarily have to be reduced to the vicinity of the shifting direction width L2 of the engaging portion 82. Note, however, that by reducing the shifting direction width L1 of the notches 72, 74, 76, 78, a greater effect can be obtained with respect to the shifting direction space and the operating force applied to the shift lever 80.

Furthermore, in the embodiment described above, the shift lever 80 is spline-fitted to the select shaft 84, and by sliding the shift lever 80 in the axial direction of the select shaft 84, the shift lever 80 is moved in the selecting direction. However, the shift lever 80 may be fixed to the select shaft 84, and the shift lever 80 may be moved in the selecting direction by moving the select shaft 84 in the axial direction using a shift actuator.

As regards rotation of the shift lever 80 about the axis of the select shaft 84, the shift lever 80 may be made capable of rotating about the axis of the select shaft 84 without being spline-fitted to the select shaft 84. In this case, the shift lever 80 may be swung by a shift actuator.

Furthermore, in the embodiment described above, gear selection is performed by moving the first through fourth shift rails 54, 56, 58, 60 to which the first through fourth shift jaws 62, 64, 66, 68 are fixed, thereby forming the gear change members of the present invention, in the shifting direction, but the form of the gear change members is not limited to this example.

For example, the first through fourth shift jaws may be capable of sliding relative to the first through fourth shift rails, and the first through fourth sleeves may be moved by connecting the first through fourth shift jaws to the first through fourth sleeves respectively using links.

Furthermore, in the embodiment described above, an engine is used as the power source, but it goes without saying that a power source other than an engine, such as an electric motor, may be used instead.

Signs used in the embodiment are defined as follows.

4 transmission mechanism; 6 first input shaft; 8 second input shaft; 18 first gear mechanism; 26 second gear mechanism; 30 output shaft; 54 first shift rail (first gear change member); 56 second shift rail (first gear change member); 58 third shift rail (second gear change member); 60 fourth shift rail (second gear change member); 62 first shift jaw (first gear change member); 64 second shift jaw (first gear change member); 66 third shift jaw (second gear change member); 68 fourth shift jaw (second gear change member); 72, 74, 76, 78 notches; 80 shift lever (shift operating member); 82 engaging portion; C1 first clutch; and C2 second clutch.

1: A transmission comprising:
a plurality of gear change members arranged for moving in a predetermined shifting direction to select a gear of a transmission mechanism; and
a shift operating member capable of moving in a selecting direction perpendicular to the shifting direction through notches formed in the gear change members, the shift operating member having an engaging portion capable of engaging with one of the gear change members via the corresponding notch to move the gear change member in the shifting direction,
wherein a gap between adjacent gear change members in the selecting direction is larger than a thickness of the engaging portion in the selecting direction.

2: The transmission according to claim 1, wherein a width of the notches in the shifting direction is set to be larger than and similar to a width of the engaging portion in the shifting direction so that the engaging portion can be fitted into one of the notches with play remaining.

3: The transmission according to claim 1, wherein the transmission mechanism comprises:
a first input shaft to which a driving force from a power source is transmitted via a first clutch;
a second input shaft to which the driving force is transmitted via a second clutch;
an output shaft arranged for outputting the driving force following speed shifting thereof;
a first gear mechanism provided between the first input shaft and the output shaft, and having a plurality of gears; and
a second gear mechanism provided between the second input shaft and the output shaft, and having a plurality of gears,
wherein, the gear change members are constituted by a first gear change member arranged for selecting a gear of said first gear mechanism, and a second gear change member arranged for selecting a gear of said second gear mechanism.
